(19) United States
(12) Patent Application Publication
(10) Pub. No.: US 2017/0169802 A1
(43) Pub. Date: Jun. 15, 2017

(54) METHOD AND DEVICE FOR SETTING DATA DISPLAY

(71) Applicant: SUZHOU ONE WORLD TECHNOLOGY CO. LTD, Suzhou Industrial Park, Jiangsu Province (CN)

(72) Inventors: Schumann Rafizadeh, Warradale (AU); Darius Rafizadeh, Suzhou (CN); Ying Hu, Suzhou (CN); Yiji Lin, Suzhou (CN)

(73) Assignee: Suzhou One World Technology Co. Ltd., Jiangsu Province (CN)

(21) Appl. No.: 15/215,212

(22) PCT Filed: Jan. 19, 2015
(86) PCT No.: PCT/CN2015/071005

§ 371 Date: Sep. 29, 2016

(30) Foreign Application Priority Data
Jan. 20, 2014 (CN) 201410025236.0

(51) Int. Cl. G09G 5/397; G06F 3/14

(52) U.S. Cl. CPC G09G 5/397; G06F 3/1423

(57) ABSTRACT

A method and a device for setting data display are provided. The method includes establishing connections with at least one flash module array system and at least one display device, wherein the flash module array system comprises at least two flash modules and the display device comprises at least two display units; storing object information of at least one to-be-displayed object into the at least two flash modules, and establishing mappings between the at least two flash modules and the at least two display units to make a display unit display object information stored in a flash module corresponding to the display unit; and storing the mappings into the flash module array system. Thus, the efficiency and the flexibility of the display setting are improved.

### CROSS REFERENCE TO RELATED APPLICATION

This application claims priority to Chinese patent application No. 201410025236.0 titled “METHOD AND DEVICE FOR SETTING DATA DISPLAY” and filed with the State Intellectual Property Office on Jan. 20, 2014, which is incorporated herein by reference in its entirety.

### TECHNICAL FIELD

The present disclosure relates to the field of communication technology, and in particular to a method and a device for setting data display.

### BACKGROUND

With the rapid development in electronic technology, a growing number of providers for a product or service select an electronic display device to display a commodity, to advertise and promote the commodity quickly and easily in different regions and nations.

Presently, a dedicated server or host is provided for the display device in general when the display for a commodity is set. The display device is connected to the corresponding server or host via a bus to display commodity information depending on the setting set by the server or host. In this way, the display device is connected to the server or host in one-to-one correspondence, thereby resulting in low efficiency, poor flexibility and high costs.

Additionally, in this way, the commodity information displayed on the display device may be stored in the display device. In this case, a mass storage device is needed for the display device. Alternatively, the commodity information may be stored in the server or host, in this case, the commodity information displayed on the display device is read from the server or host, and thus the response speed of the display device is reduced.

### SUMMARY

In view of the above, embodiments of the disclosure provide method and device for setting data display, to make object information set quickly and easily.

To address the above-mentioned issues, technical solutions are provided as follows according to the embodiments of the disclosure.

A method for setting data display is provided, the method includes:

establishing connections with at least one flash module array system and at least one display device, wherein the flash module array system includes at least two flash modules and the display device includes at least two display units;

storing object information of at least one to-be-displayed object into the at least two flash modules, and establishing mappings between the at least two flash modules and the at least two display units to make a display unit display object information stored in a flash module corresponding to the display unit; and

storing the mappings into the flash module array system.

The process of establishing connections with the flash module array system includes:

receiving identity information and an operation type input by a user for accessing the to-be-connected flash module array system;

authenticating an identity of the user; and

connecting to a flash module array system corresponding to the identity information to perform a corresponding operation in the case that the user is permitted to perform an operation of the operation type.

The process of establishing the mapping between the at least two flash modules and the at least two display units includes:

grouping the to-be-displayed objects based on a preset condition; and

mapping flash modules in which the object information of the to-be-displayed objects in a same group is stored to the same display unit.

The method further includes:

setting timesharing for displaying the object information on each display unit; and

setting a period of time for displaying each piece of object information on the display unit based on the timesharing for each display unit. The timesharing is used to share a display time among different objects.

The method further includes:

querying for the object information stored in the flash module array system in a predetermined cycle; and

deleting or changing the object information after a validity period expires in the case that the object information has the validity period.

The method further includes:

establishing an access connection with the display device, and sending an access request to the display device, wherein the access request includes a code of a to-be-accessed object; and

querying, by the display device, the flash module array system depending on the code to access the to-be-accessed object in a real-time manner.

A device for setting data display, includes:

a connection establishing unit configured to establish connections with at least one flash module array system and at least one display device, wherein the flash module array system includes at least two flash modules and the display device includes at least two display units;

an object information storing unit configured to store object information of at least one to-be-displayed object into the at least two flash modules;

a mapping unit configured to establish mappings between the at least two flash modules and the at least two display units make a display unit display object information stored in a flash module corresponding to the display unit; and

a mapping storing unit configured to store the mappings into the flash module array system.

The connection establishing unit includes:

a receiving sub-unit configured to receive identity information and an operation type input by a user for accessing the to-be-connected flash module array system;

an authenticating sub-unit configured to authenticate an identity of the user; and

a connecting sub-unit configured to connect to a flash module array system corresponding to the identity information to perform a corresponding operation in the case that the user is permitted to perform an operation of the operation type.

The mapping unit includes:

a grouping sub-unit configured to group the to-be-displayed objects based on a preset condition; and

a mapping sub-unit configured to map flash modules in which the object information of the to-be-displayed objects in a same group is stored to the same display unit.

The device further includes:

a timesharing setting unit configured to set timesharing for displaying the object information on each display unit; and

a display time setting unit configured to set a period of time for displaying each piece of object information on the display unit based on the timesharing schemed for each display unit.

The device further includes:

a querying unit configured to query for the object information stored in the flash module array system in a predetermined cycle; and

a deleting or changing unit configured to delete or change the object information after a validity period expires in the case that the object information has the validity period.

The device further includes:

an access connection unit configured to establish an access connection with the display device and send an access request to the display device, wherein the access request includes a code of a to-be-accessed object, wherein the code is for the display device querying the flash module array system depending to access the to-be-accessed object in a real-time manner.

For the method and device for setting data display according to the embodiments of the disclosure, the device for setting data display is connected to at least one flash module array system and at least one display device. The display device provides at least two display units for displaying. The information of the to-be-displayed object is stored in different flash modules in the flash module array system at the same time, and the display is set by establishing mappings between the flash modules and the display unit. In this case, the devices for setting data display can be connected with the flash module array systems and the display devices in one-to-many, many-to-one or many-to-many correspondences. It is not necessary to provide a dedicated server for the display device, and the efficiency and flexibility for the display setting are improved. In addition, the object information displayed on the display device may be read directly from the flash module which has mappings with the display unit, and therefore the response speed of the display device is ensured effectively.

### BRIEF DESCRIPTION OF THE DRAWINGS

In order to illustrate the technical solutions according to the embodiments of the disclosure or in the conventional technology more clearly, the drawings to be used in the description of the conventional technology or the embodiments will be described briefly hereinafter. Apparently, the drawings described hereinafter only illustrate some embodiments of the present disclosure, and other drawings may be obtained by those skilled in the art according to those drawings without creative effort.

FIG. 1 is a flowchart of a method for setting data display according to a first embodiment of the disclosure;

FIG. 2 is a schematic diagram of a flash module array system according to the disclosure;

FIG. 3 is a flowchart of a method for setting data display according to a second embodiment of the disclosure;

FIG. 4 is a flowchart of a method for setting data display according to a third embodiment of the disclosure;

FIG. 5 is a flowchart of a method for setting data display according to a fourth embodiment of the disclosure;

FIG. 6 is a flowchart of connecting a device for setting data display to a Flash Module Array System (FMAS) according to the disclosure; and

FIG. 7 is a schematic diagram of a device for setting data display according to the disclosure.

### DETAILED DESCRIPTION

Hereinafter, the technical solutions in the embodiments of the present disclosure will be described clearly and completely in conjunction with the drawings in the embodiments of the present disclosure. Apparently, the described embodiments are only a part of the embodiments of the present disclosure. All the other embodiments obtained by those skilled in the art based on the embodiments of the present disclosure without creative effort will fall within the scope of protection of the disclosure.

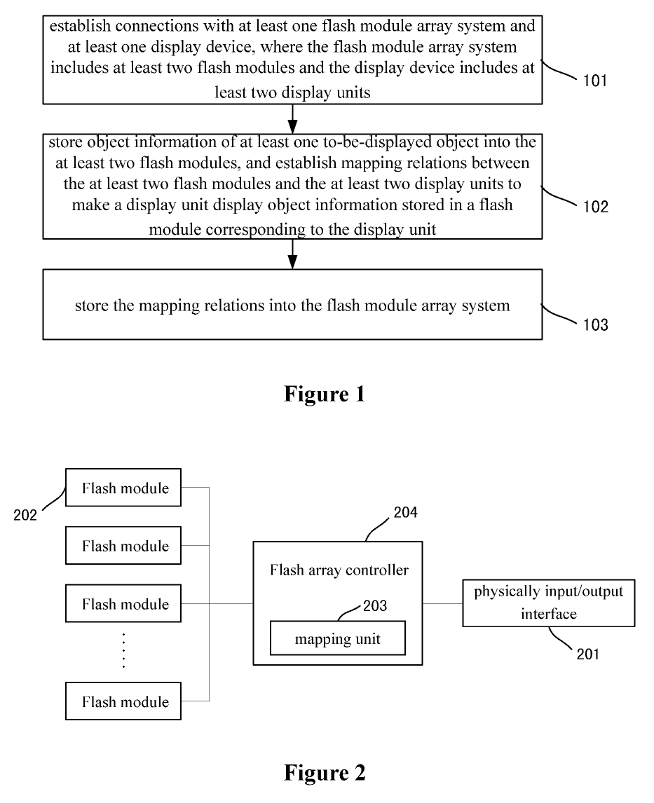

A flowchart of a method for setting data display according to a first embodiment of the disclosure is shown in FIG. 1, which may include steps 101 to 103.

In step 101, connections with at least one flash module array system and at least one display device is established, where the flash module array system includes at least two flash modules and the display device includes at least two display units.

The solution in the disclosure mainly relates to three parts, including a device for setting data display, a flash module array system and a display device.

1. The Device for Setting Data Display (Hereinafter Abbreviated as “the Device”)

The device for setting data display is an executive entity in the solution of the disclosure, which may be embodied as a dedicated device with the functions provided in the disclosure, such as a dedicated device loading a software control panel with the functions provided in the disclosure, or may be embodied as an intelligent terminal (such as a mobile phone, a PDA, a computer or a tablet) loading the functions provided in the disclosure, such as an intelligent terminal loading a software control panel (SoftPanel) with the functions provided in the disclosure, which is not limited in the disclosure. The specific functions of the device for setting data display may refer to the introduction below, which is not described in detail herein.

2. The FMAS

A schematic diagram of the flash module array system according to the disclosure is shown in FIG. 2, which may include a physical input/output interface 201, at least two flash modules 202, a mapping unit 203 and a flash array controller 204.

The physical input/output interface 201 is configured to exchange data with outside world.

The at least two flash modules 202 are configured to store data in serial or parallel.

The flash array controller 204 including the mapping unit 203 is configured to store the mappings between logical addresses and physical addresses. The physical input/output interface exchanges data with the external by means of the logical addresses, and the physical input/output interface exchanges data with the internal of the array by means of the physical addresses.

FMAS shown in FIG. 2 may have more storage capacity, faster access speed and lower power consumption. In the solution of the disclosure, FMAS is mainly used to store the object information of the object, such as a name of the object, a code of the object, a provider for the object, an access type (such as purchase, exchange, bidding, coupon) of the object, a stock of the object, a display time for the object, a validity period for displaying the object.

It should be noted that the object information may be stored based on the above-described flash module array system solution in conjunction with the solutions disclosed in Chinese patents No. ZL201010234704.7, No. ZL201010274777.9 as needed, which is not limited in the disclosure, in order to improve the expandability of the flash module array and achieve more storage capacity and higher performance.

3. The Display Device

The display device concretely refers to an electronic display device provided in public for displaying the object to the people. The display device may provides at least two display units as needed, and the display units may present in a same shape, or in different shapes, which is not limited in the disclosure.

The display device in the disclosure has at least two functions, displaying the object information in a continuous loop automatically in one aspect and providing the user with a real-time object access service in another aspect.

In order that the display device implements the function of displaying the object information in a continuous loop automatically, firstly the object information to be displayed on the display unit of the display device is set, for which the first embodiment is provided. In the step 101, the device is connected to FMAS for storing the object information and the display device for displaying the object information in wire or wireless manner, to prepare the technology for the subsequent data display setting process.

In step 102, object information of at least one to-be-displayed object is stored into the at least two flash modules, and mappings between the at least two flash modules and the at least two display units are established to make a display unit display object information stored in a flash module corresponding to the display unit.

In step 103, the mappings are stored into the flash module array system.

The data display setting process is completed by the following three steps, after the connection between the device and FMAS and the connection between the device and the display device are established.

1. Storing the Object Information of the to-be-Displayed Object into the Flash Module

The object information is provided by the provider. The object information of the object is stored into the flash module after the to-be-displayed object that needs to be set at this time is determined. In practice, the object information may be stored into different flash modules in order based on the code of the to-be-displayed object; alternatively, the object information of the to-be-displayed object may be stored into different flash modules based on a preset rule (such as the access type, the provider or the object type, etc.). That is, the information of the object conforming to the same rule is stored into one flash module, which is not limited in the disclosure.

2. Establishing Mappings Between the Flash Modules and the Display Units

After the object information is stored into the flash modules, a display position of the object displayed on the display device is further determined, and mappings between the flash modules for storing the object information and the display units for displaying the object information are established. The display unit is used to display the object information stored in a flash module according to mappings with the display unit.

The process of establishing mappings between the flash modules and the display units according to the disclosure, as an implementation, may include: grouping the to-be-displayed objects based on a preset condition; and mapping the flash module in which the object information of the to-be-displayed objects in a same group is stored to a same display unit.

The mappings between the flash modules and the display units may be a mapping between a flash modules in one FMAS and a display unit in one display device, alternatively, may be mappings between flash modules in one FMAS and display units in multiple display devices, alternatively, may be mappings between flash modules in multiple FMASs and display units in multiple display devices.

For example, in the case that a flash module array system A includes four flash modules A1, A2, A3 and A4, and a display device B includes four display units B1, B2, B3 and B4, the device may establish a mapping between A1 and B1 (that is, the object information stored in A1 is displayed on B1), a mapping between A2 and B2, a mapping between A3 and B3 and a mapping between A4 and B4. Alternatively, in the case that the display device B includes three display units B1, B2 and B3, the device may establish a mapping between A1 and B1, a mapping between A2 and B2 and mappings between A3, A4 and B3 (that is, the object information stored in A3, A4 belongs to one group, and the object information stored in A3, A4 is displayed on B3).

For example, in the case that the flash module array system A includes four flash modules A1, A2, A3 and A4, the display device B includes two display units Bland B2, a display device C includes four display units C1, C2, C3 and C4, and a display device D includes three display units D1, D2 and D3, the device may establish a mapping between A1 and B1, a mapping between A2 and C1, a mapping between A3 and D3 and a mapping between A4 and D1.

Certainly, there are further other mappings between flash modules and the display units, in addition to the examples described above, which is not listed one by one herein, and which is not limited in the disclosure.

3. Storing the Mappings Between the Flash Modules and the Display Units

In order that the display device read the object information from FMAS accurately and the mappings between the flash modules and the display units are maintained and modified conveniently, the mappings may be stored in FMAS after the mappings between the flash modules and the display units is established, for example, the mappings may be stored in a module mapping unit.

The display setting for the object information is achieved by the device according to the disclosure through the above described steps, and then the display device may read the object information from the corresponding FMAS, and send the object information to the preset position (i.e., a display unit) to display for the user. Hence, technical support is provided for the display device displaying the object information in a continuous loop.

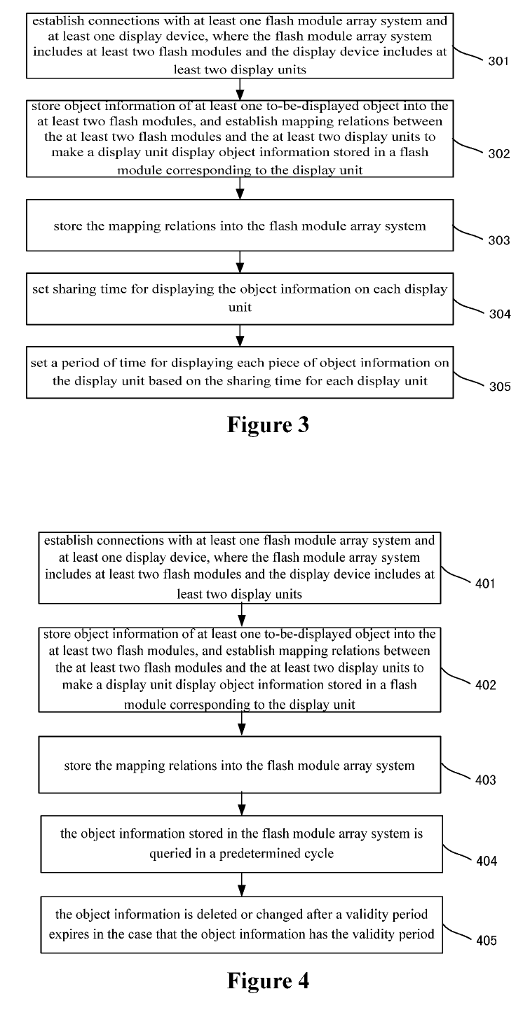

A flowchart of a method for setting data display according to a second embodiment of the disclosure is shown in FIG. 3. The method may include steps 301 to 305.

In step 301, connections with at least one flash module array system and at least one display device is established, where the flash module array system includes at least two flash modules and the display device includes at least two display units.

In step 302, object information of at least one to-be-displayed object is stored into the at least two flash modules, and mappings between the at least two flash modules and the at least two display units are established to make a display unit display object information stored in a flash module corresponding to the display unit.

In step 303, the mappings are stored into the flash module array system.

The steps 301 to 303 are the same as the steps 101 to 103, which is not repeated any more herein.

In step 304, timesharing for displaying the object information on each display unit is set.

In step 305, a period of time for displaying each piece of object information on the display unit is set based on the timesharing for each display unit.

To display the object information in a continuous loop automatically, a display time for each object is set, in order to jump to display a next object after the display time for the current object expires, repeating this to display the object information in a continuous loop.

A timesharing of the display unit which the object belongs to is set before the display time for each object is set, where the timesharing refers to a duration of each loop process for the display unit. The display time for each object is set based on information, such as the number of objects to be displayed on the display unit, the duration for playing the object at one time. It should be noted that the display time for the objects on one display unit may be the same, or different, which is not limited in the disclosure.

Furthermore, in practice, the display time for each object may be set in advance as a parameter of the object information, and then the steps 301 to 303 are performed to set the mappings between the flash modules and the display units.

A flowchart of a method for setting data display according to a third embodiment of the disclosure is shown in FIG. 4. The method may include steps 401 to 405.

In step 401, connections with at least one flash module array system and at least one display device is established, where the flash module array system includes at least two flash modules and the display device includes at least two display units.

In step 402, object information of at least one to-be-displayed object is stored into the at least two flash modules, and mappings between the at least two flash modules and the at least two display units are established to display object information stored in each flash module on the display unit corresponding to the flash module.

In step 403, the mappings are stored into the flash module array system.

The steps 401 to 403 are the same as the steps 101 to 103, which are not repeated any more herein.

In step 404, the object information stored in the flash module array system is queried in a predetermined cycle.

In step 405, the object information is deleted or changed after a validity period expires in the case that the object information has the validity period.

The device may set the validity period for displaying the object depending on a requirement of the provider, after the mappings between the flash modules and the display units are established. Alternatively, the validity period for displaying the object is set in advance as a parameter of the object information, before the mappings are established.

In this case, the device may query for the object information stored in FMAS at regular intervals to determine whether there is expired object information. No processing is made in the case that there is no expired object information; the expired object information is deleted or changed as needed in the case that there is expired object information.

It should be noted that all of the object information of the object may be deleted, that is, the object is not displayed any more. Alternatively, a part of the object information of the object may be deleted, that is, the object may be displayed sequentially, but the part of the deleted object information of the object are not displayed any more, such as information of limited time discount offer, information of presenting limited quantity. The discount information is deleted once the limited time expires, or the presenting information is deleted once the limited quantity is exhausted.

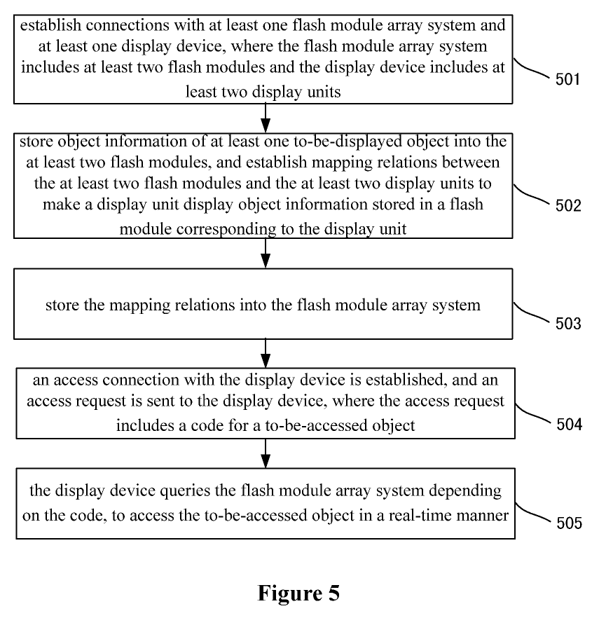

A flowchart of a method for setting data display according to a fourth embodiment of the disclosure is shown in FIG. 5. The method may include steps 501 to 505.

In step 501, connections with at least one flash module array system and at least one display device is established, where the flash module array system includes at least two flash modules and the display device includes at least two display units.

In step 502, object information of at least one to-be-displayed object is stored into the at least two flash modules, and mappings between the at least two flash modules and the at least two display units are established to make a display unit display object information stored in a flash module corresponding to the display unit.

In step 503, the mappings are stored into the flash module array system.

The steps 501 to 503 are the same as the steps 101 to 103, which are not repeated any more herein.

In step 504, an access connection with the display device is established, and an access request is sent to the display device, where the access request includes a code for a to-be-accessed object.

In step 505, the display device queries the flash module array system depending on the code to access the to-be-accessed object in a real-time manner.

The display device may display the object information for the user in a continuous loop and provide the user with a real-time online access service after the display for the object information is set in the way as above.

Firstly the access connection between the device and the display device is established, and then the access request is sent to the display device to trigger the display device to provide the user with the online access service in the case that the user wants to access the object of interest in a real-time manner via the device. For example, to buy a book displayed on the display device, to purchase a commodity displayed on the display device, to book a hotel room displayed on the display device and the like. The access request includes at least a code for a to-be-accessed object. In this case, the display device queries all the flash modules which have mappings with the display units of the display device depending on the code of the object upon reception of the access request, to obtain provider information for the to-be-accessed object. The display device sends the access request of the user to the provider, and establishes an access relation between the user and the provider in a real-time manner. It should be noted that the protocol for implementing the access process according to the disclosure is an application layer protocol.

It should be noted that the code of the object in the disclosure is unique as the identification of the object. As an implementation for the code of the object in the disclosure, the numerical order of the object being delivered may be used as the code of the object. Alternatively, the code of the object may be set in a specific rule. For example, the code of the object may be formed of a manufacturer key in predetermined bits, an access type and an object key. The manufacturer key is unique as the identification of the provider, which may be formed of digits in predetermined bits, letters and special characters. The object key is unique as the identification of one object among different objects of the same manufacturer. The object key may be formed of digits in predetermined bits, letters and special characters. The access type may indicate the current accessing behavior of the user, such as bidding in purchase, exchanging in barter, downloading a coupon, and so on. Alternatively, the access type may also indicate a range of the user accessing behavior. For example, the range of the accessing behavior for a certain object may be local, national or global. The specific form of the code of the object is not defined in the disclosure, as long as it is ensured that the code of the object is unique.

Hereinafter purchasing a commodity displayed on the display device is taken as an example to explain the real-time access process according to the disclosure.

A user holds a promotion voucher of a certain object, and the promotion voucher includes at least the following information: the code of the object, available promotion amount and the provider information. In this case, the user establishes communication with the display device via the device and inputs the number of the promotion voucher by any method such as manual input, scanning input, etc. The display device may determine the object to be accessed by the user currently base on the code of the object included in the promotion voucher and determine the provider for the object based on the provider information upon reception of the number of the promotion voucher input by the user. And then the display device submits an access request to the provider to achieve the real-time access between the user and the provider. The provider calculates the costs of the object and completes the payment by deducting the available promotion amount upon reception of the access request. In this way, it is only to input the number of the promotion voucher by the user and then a serial of operations such as access, purchase and payment can be completed during the whole access process, and therefore transaction process is simplified and user experience is improved.

The users are grouped into an administrator and an ordinary user based on the functions provided by the device according to the disclosure. The ordinary user can access the object in a real-time manner by using the device, and the administrator can not only access the object in a real-time manner, but also set FMAS and the display device. Furthermore, different permissions may be set for the administrator based on different set parameters, such as a permission for setting the mappings between the flash modules and the display units, a permission for setting the display time for the object, a permission for setting the validity period for the object, a permission for deleting or changing the object information.

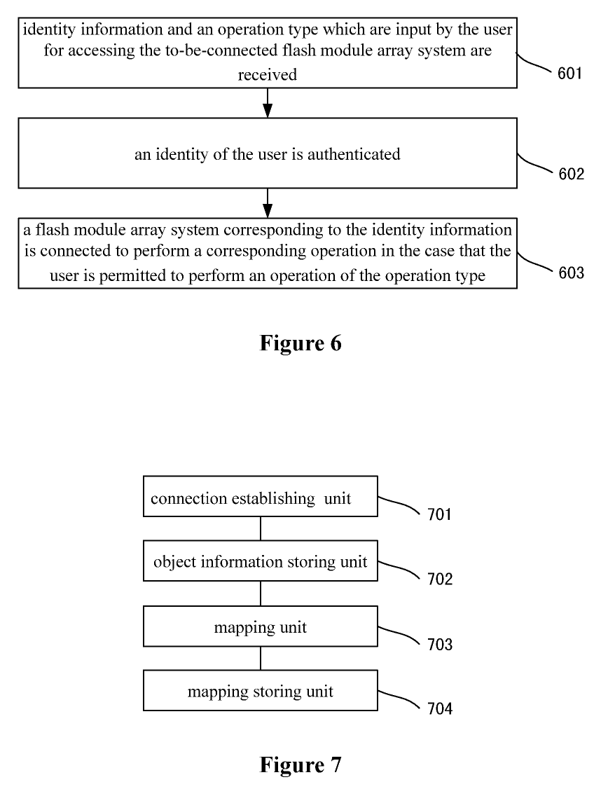

The process of establishing a connection between the device and FMAS according to the disclosure is embodied as the flowchart shown in FIG. 6 in conjunction with the user grouping and different permissions of the administrator, which may include steps 601 to 603.

In step 601, identity information and an operation type which are input by the user for accessing the to-be-connected flash module array system are received.

In step 602, an identity of the user is authenticated.

In step 603, a flash module array system corresponding to the identity information is connected to perform a corresponding operation in the case that the user is permitted to perform an operation of the operation type.

The device may prompt the user to perform identity authentication and permission authentication to verify the validity of user's current behavior when the user establishes a connection with FMAS via the device. Correspondingly, the device obtains the identity information (such as a user name, a password, and so on) of the user to determine whether the user is a registered valid user. It is further determined whether the user is permitted to perform an operation of the operation type based on the operation type to be performed by the user in the case that the identity information of the user is verified to be valid. The device sends a connection request to FMAS to connect to the specified FMAS only if the valid user performs the operation which conforms to the permission of the user.

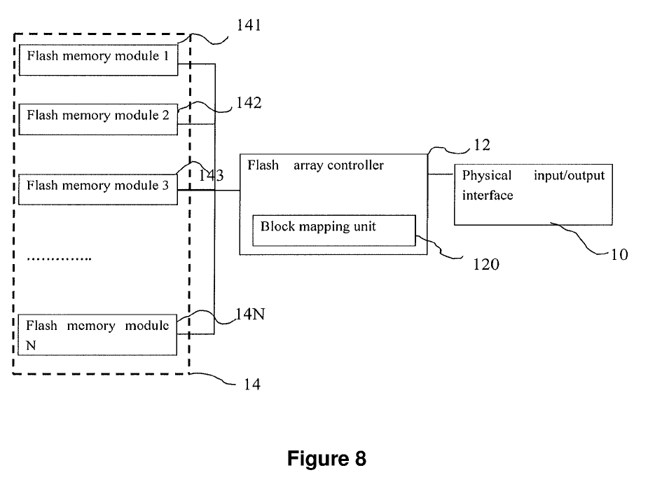

A device for setting data display is further disclosed according to another embodiment of the disclosure. Referring to FIG. 7, the device may include a connection establishing unit 701, an object information storing unit 702, a mapping unit 703 and a mapping storing unit 704.

The connection establishing unit 701 is configured to establish connections with at least one flash module array system and at least one display device, where the flash module array system includes at least two flash modules and the display device includes at least two display units.

The object information storing unit 702 is configured to store object information of at least one to-be-displayed object into the at least two flash modules.

The mapping unit 703 is configured to establish mappings between the at least two flash modules and the at least two display units to make a display unit display object information stored in a flash module corresponding to the display unit.

The mapping storing unit 704 is configured to store the mappings into the flash module array system.

The connection establishing unit 701 may include:

a receiving sub-unit configured to receive identity information and an operation type input by a user for accessing the to-be-connected flash module array system;

an authenticating sub-unit configured to authenticate an identity of the user; and

a connecting sub-unit configured to connect to a flash module array system corresponding to the identity information to perform a corresponding operation in the case that the user is permitted to perform an operation of the operation type.

The mapping unit 703 may include:

a grouping sub-unit configured to group the to-be-displayed objects based on a preset condition; and

a mapping sub-unit configured to map flash modules in which the object information of the to-be-displayed objects in a same group is stored to the same display unit.

Corresponding to the method according to the second embodiment, the device for setting data display may further include, based on the schematic diagram shown in FIG. 7:

a timesharing setting unit configured to set timesharing for displaying the object information on each display unit; and

a display time setting unit configured to set a period of time for displaying each piece of object information on the display unit based on the timesharing schemed for each display unit.

Corresponding to the method according to the third embodiment, the device for setting data display may further include, based on the schematic diagram shown in FIG. 7:

a querying unit configured to query for the object information stored in the flash module array system in a predetermined cycle; and

a deleting or changing unit configured to delete or change the object information after a validity period expires in the case that the object information has the validity period.

Corresponding to the method according to the fourth embodiment, the device for setting data display may further include, based on the schematic diagram shown in FIG. 7:

an access connection unit configured to establish an access connection with the display device and send an access request to the display device, where the access request includes a code of a to-be-accessed object, and the display device queries the flash module array system depending on the code to access the to-be-accessed object in a real-time manner.

It should be noted that, various embodiments in the specification are described in a progressive way. For the same or similar parts between various embodiments, one may refer to the description of other embodiments, and each embodiment highlights the differences from other embodiments. Particularly, for the apparatus embodiments, since they are substantially similar to the method embodiments, the description is relatively simple; and for the related parts, one may refer to the corresponding illustration of the method embodiments. The apparatus embodiments described above are only schematic, the units illustrated as separate components may be physically separated or not; and the components displayed as units may be physical units or not, i.e., the components may be located at one place or may be distributed on multiple network units. Some or all of the modules may be selected based on the actual need to realize the objects of the solutions of the embodiment. One skilled in the art can understand and implement the disclosure easily.

Only a few embodiments of the disclosure are described above. This is not intended to limit the scope of the disclosure. Any changes, equivalent substitutions or modifications made within the spirit and principle of the embodiments of the disclosure fall within the scope of protection of the embodiments of the disclosure.

1. A method for setting data display, comprising:
establishing connections with at least one flash module array system and at least one display device, wherein the flash module array system comprises at least two flash modules and the display device comprises at least two display units;
storing object information of at least one to-be-displayed object into the at least two flash modules, and establishing mappings between the at least two flash modules and the at least two display units to make a display unit display object information stored in a flash module corresponding to the display unit; and
storing the mappings into the flash module array system.

2. The method according to claim 1, wherein the process of establishing connections with the flash module array system comprises:
receiving identity information and an operation type input by a user for accessing the to-be-connected flash module array system;
authenticating an identity of the user; and
connecting to a flash module array system corresponding to the identity information to perform a corresponding operation in the case that the user is permitted to perform an operation of the operation type.

3. The method according to claim 1, wherein the process of establishing mappings between the at least two flash modules and the at least two display units comprises:
grouping the to-be-displayed objects based on a preset condition; and
mapping flash modules in which the object information of the to-be-displayed objects in a same group is stored to the same display unit.

4. The method of claim 1, further comprising
setting timesharing for displaying the object information on each display unit; and
setting a period of time for displaying each piece of object information on the display unit based on the timesharing for each display unit.

5. The method of claim 1, further comprising
querying for the object information stored in the flash module array system in a predetermined cycle; and
deleting or changing the object information after a validity period expires in the case that the object information has the validity period.

6. The method of claim 1, further comprising
establishing an access connection with the display device, and sending an access request to the display device, wherein the access request comprises a code of a to-be-accessed object; and
querying, by the display device, the flash module array system depending on the code to access the to-be-accessed object in a real-time manner.

7. A device for setting data display, comprising:
a connection establishing unit configured to establish connections with at least one flash module array system and at least one display device, wherein the flash module array system comprises at least two flash modules and the display device comprises at least two display units;
an object information storing unit configured to store object information of at least one to-be-displayed object into the at least two flash modules;
a mapping unit configured to establish mappings between the at least two flash modules and the at least two display units make a display unit display object information stored in a flash module corresponding to the display unit; and
a mapping storing unit configured to store the mappings into the flash module array system.

8. The device according to claim 7, wherein the connection establishing unit comprises:
a receiving sub-unit configured to receive identity information and an operation type input by a user for accessing the to-be-connected flash module array system;
an authenticating sub-unit configured to authenticate an identity of the user; and
a connecting sub-unit configured to connect to a flash module array system corresponding to the identity information to perform a corresponding operation in the case that the user is permitted to perform an operation of the operation type.

9. The device according to claim 7, wherein the mapping unit comprises:
a grouping sub-unit configured to group the to-be-displayed objects based on a preset condition; and
a mapping sub-unit configured to map flash modules in which the object information of the to-be-displayed objects in a same group is stored to the same display unit.

10. The device of claim 7, further comprising
a timesharing setting unit configured to set timesharing for displaying the object information on each display unit; and
a display time setting unit configured to set a period of time for displaying each piece of object information on the display unit based on the timesharing for each display unit.

11. The device of claim 7, further comprising
a querying unit configured to query for the object information stored in the flash module array system in a predetermined cycle; and
a deleting or changing unit configured to delete or change the object information after a validity period expires in the case that the object information has the validity period.

12. The device of claim 7 further comprising
an access connection unit configured to establish an access connection with the display device and send an access request to the display device, wherein the access request comprises a code of a to-be-accessed object, wherein the code is for the display device querying the flash module array system depending to access the to-be-accessed object in a real-time manner.

13. The method of claim 1, wherein the process of establishing connections with the flash module array system comprises:
receiving identity information and an operation type input by a user for accessing the to-be-connected flash module array system;
authenticating an identity of the user; and
connecting to a flash module array system corresponding to the identity information to perform a corresponding operation in the case that the user is permitted to perform an operation of the operation type;
the method further comprising
setting timesharing for displaying the object information on each display unit; and
setting a period of time for displaying each piece of object information on the display unit based on the timesharing for each display unit.

14. The method of claim 1, wherein the process of establishing mappings between the at least two flash modules and the at least two display units comprises:
grouping the to-be-displayed objects based on a preset condition; and
mapping flash modules in which the object information of the to-be-displayed objects in a same group is stored to the same display unit;
the method further comprising
setting timesharing for displaying the object information on each display unit; and
setting a period of time for displaying each piece of object information on the display unit based on the timesharing for each display unit.

15. The method of claim 1, wherein the process of establishing connections with the flash module array system comprises:
receiving identity information and an operation type input by a user for accessing the to-be-connected flash module array system;
authenticating an identity of the user; and
connecting to a flash module array system corresponding to the identity information to perform a corresponding operation in the case that the user is permitted to perform an operation of the operation type;
the method further comprising
querying for the object information stored in the flash module array system in a predetermined cycle; and
deleting or changing the object information after a validity period expires in the case that the object information has the validity period.

16. The method of claim 1, wherein the process of establishing mappings between the at least two flash modules and the at least two display units comprises:
grouping the to-be-displayed objects based on a preset condition; and
mapping flash modules in which the object information of the to-be-displayed objects in a same group is stored to the same display unit;
the method further comprising
querying for the object information stored in the flash module array system in a predetermined cycle; and
deleting or changing the object information after a validity period expires in the case that the object information has the validity period.

17. The method of claim 1, wherein the process of establishing connections with the flash module array system comprises:
receiving identity information and an operation type input by a user for accessing the to-be-connected flash module array system;
authenticating an identity of the user; and
connecting to a flash module array system corresponding to the identity information to perform a corresponding operation in the case that the user is permitted to perform an operation of the operation type;
the method further comprising
establishing an access connection with the display device, and sending an access request to the display device, wherein the access request comprises a code of a to-be-accessed object; and
querying, by the display device, the flash module array system depending on the code to access the to-be-accessed object in a real-time manner.

18. The method according to claim 1, wherein the process of establishing mappings between the at least two flash modules and the at least two display units comprises:
grouping the to-be-displayed objects based on a preset condition; and
mapping flash modules in which the object information of the to-be-displayed objects in a same group is stored to the same display unit;
the method further comprising
establishing an access connection with the display device, and sending an access request to the display device, wherein the access request comprises a code of a to-be-accessed object; and
querying, by the display device, the flash module array system depending on the code to access the to-be-accessed object in a real-time manner.

19. The device of claim 7, wherein the connection establishing unit comprises:
a receiving sub-unit configured to receive identity information and an operation type input by a user for accessing the to-be-connected flash module array system;
an authenticating sub-unit configured to authenticate an identity of the user; and
a connecting sub-unit configured to connect to a flash module array system corresponding to the identity information to perform a corresponding operation in the case that the user is permitted to perform an operation of the operation type;
the device further comprising
a timesharing setting unit configured to set timesharing for displaying the object information on each display unit; and
a display time setting unit configured to set a period of time for displaying each piece of object information on the display unit based on the timesharing for each display unit.

20. The device of claim 7, wherein the mapping unit comprises:
a grouping sub-unit configured to group the to-be-displayed objects based on a preset condition; and
a mapping sub-unit configured to map flash modules in which the object information of the to-be-displayed objects in a same group is stored to the same display unit;
the device further comprising
a timesharing setting unit configured to set timesharing for displaying the object information on each display unit; and
a display time setting unit configured to set a period of time for displaying each piece of object information on the display unit based on the timesharing for each display unit.

21. The device of claim 7, wherein the connection establishing unit comprises:
a receiving sub-unit configured to receive identity information and an operation type input by a user for accessing the to-be-connected flash module array system;
an authenticating sub-unit configured to authenticate an identity of the user; and
a connecting sub-unit configured to connect to a flash module array system corresponding to the identity information to perform a corresponding operation in the case that the user is permitted to perform an operation of the operation type;
the device further comprising
a querying unit configured to query for the object information stored in the flash module array system in a predetermined cycle; and
a deleting or changing unit configured to delete or change the object information after a validity period expires in the case that the object information has the validity period.

22. The device of claim 7, wherein the mapping unit comprises:
a grouping sub-unit configured to group the to-be-displayed objects based on a preset condition; and
a mapping sub-unit configured to map flash modules in which the object information of the to-be-displayed objects in a same group is stored to the same display unit;
the device further comprising
a querying unit configured to query for the object information stored in the flash module array system in a predetermined cycle; and
a deleting or changing unit configured to delete or change the object information after a validity period expires in the case that the object information has the validity period.

23. The device of claim 7, wherein the connection establishing unit comprises:
a receiving sub-unit configured to receive identity information and an operation type input by a user for accessing the to-be-connected flash module array system;
an authenticating sub-unit configured to authenticate an identity of the user; and
a connecting sub-unit configured to connect to a flash module array system corresponding to the identity information to perform a corresponding operation in the case that the user is permitted to perform an operation of the operation type
the device further comprising
an access connection unit configured to establish an access connection with the display device and send an access request to the display device, wherein the access request comprises a code of a to-be-accessed object, wherein the code is for the display device querying the flash module array system depending to access the to-be-accessed object in a real-time manner.

24. The device of claim 7, wherein the mapping unit comprises:
a grouping sub-unit configured to group the to-be-displayed objects based on a preset condition; and
a mapping sub-unit configured to map flash modules in which the object information of the to-be-displayed objects in a same group is stored to the same display unit;
the device further comprising
